(19) United States
(12) Patent Application Publication
(10) Pub. No.: US 2012/0062509 A1
(43) Pub. Date: Mar. 15, 2012

(54) CAPACITIVE TOUCH PANEL

(75) Inventor: Jane HSU, Guishan Township (TW)

(73) Assignee: DERLEAD INVESTMENT LTD., Taipei (TW)

(21) Appl. No.: 13/224,717

(22) Filed: Sep. 2, 2011

(30) Foreign Application Priority Data
Sep. 9, 2010 (TW) 099217477

(51) Int. Cl. G06F 3/044

(52) U.S. Cl. 345/174; 178/18.06

(57) ABSTRACT

A capacitive touch panel has a substrate, a medium layer and multiple leading wires. The medium layer is formed on the substrate and has a rough surface, two sense units arranged along two different axial directions, and each sense unit has multiple touch points. The leading wires are formed on the leading wire segment of the medium layer are and electrically connected with the touch points of the sense units. Accordingly, the leading wires can be securely combine with the leading wire segment of the medium layer due to the arrangement of the rough surface and can be kept from detaching from the medium layer.

### BACKGROUND OF THE INVENTION

1. Field of the Invention

The present invention relates to a capacitive touch panel, and more particularly to a capacitive touch panel having a medium layer with a rough surface to securely combine with leading wires.

2. Description of Related Art

Touch panels have many types including capacitive, resistive, surface acoustic wave and optical types. A capacitive touch panel has characters of dust-proofing, fire-proofing, scrape-proofing and high perviousness of light and may have a hard coat layer to provide a protecting effect to the touch panel. The conventional capacitive touch panels are widely used in finance systems, medical treatment systems, public information systems, video game systems or the like and include surface-capacitive touch panels and projected-capacitive touch panels. The projected-capacitive touch panels can be operated by multiple touch points including press, reduction, magnification, rolling and rotation by fingers and are widely applied on video apparatuses and iPhones.

The conventional projected-capacitive touch panels include two types of self capacitance and mutual capacitance. The conventional self capacitance touch panels, also known as axis intersect touch panels, include a single layer of substrate or two layers of substrates. The single layer of substrate has multiple touch points made of Indium Tin Oxide (ITO), formed along different axial directions and arranged crisscross. Alternatively, each of two layers of substrates has multiple touch points formed along different axial directions and arranged crisscross after the layers of substrate are combined with each other. Multiple leading wires are provided to electrically connect with the touch points.

The conventional mutual capacitance touch panels, also known as all points addressable (APA) touch panels, has two layers of substrates. The substrates have multiple touch points formed along different axial directions and overlapped with each other. Multiple leading wires are provided to electrically connect with the touch points.

The leading wires are formed on the substrate by sputtering deposition or spraying plating process and the substrate is glass. Accordingly, the leading wires of the conventional capacitive touch panel should have a sufficient wide for combined with the glass substrate. Consequently, the area on the substrate for mounting the leading wires has to be enlarged, and the area for arranging the touch points is accordingly reduced. However, to fit with the design of multi-functional capacitive touch panel, the area for arranging the touch points has to be enlarged, so the area for mounting the leading wires has to be reduced. Therefore, the wide of the leading wires has to be decrease, but the leading wires are easily broken or detached from the substrate.

Taiwan Utility Model No. M387310 disclosed a conventional touch panel having leading wires printed directly on the substrate.

To overcome the shortcomings, the present invention tends to provide a capacitive touch panel to mitigate or obviate the aforementioned problems.

### SUMMARY OF THE INVENTION

The main objective of the invention is to provide a capacitive panel having a medium layer with a rough surface to securely combine with leading wires.

The capacitive touch panel has a substrate, a medium layer and multiple leading wires. The medium layer is formed on the substrate and has a rough surface, two sense units arranged along two different axial directions, and each sense unit has multiple touch points. The leading wires are formed on the leading wire segment of the medium layer are and electrically connected with the touch points of the sense units.

Other objects, advantages and novel features of the invention will become more apparent from the following detailed description when taken in conjunction with the accompanying drawings.

### BRIEF DESCRIPTION OF THE DRAWINGS

FIG. 1 is a top view of a first embodiment of a capacitive touch panel in accordance with the present invention;

FIG. 2 is a front view of the capacitive touch panel in FIG. 1;

FIG. 3 is an enlarged front view of the capacitive touch panel in FIG. 1;

FIG. 4 is a front view of a second embodiment of a capacitive touch panel in accordance with the present invention;

FIG. 5 is a front view of a third embodiment of a capacitive touch panel in accordance with the present invention;

FIG. 6 is a front view of a fourth embodiment of a capacitive touch panel in accordance with the present invention; and

FIG. 7 is a front view of a fifth embodiment of a capacitive touch panel in accordance with the present invention.

### DETAILED DESCRIPTION OF PREFERRED EMBODIMENT

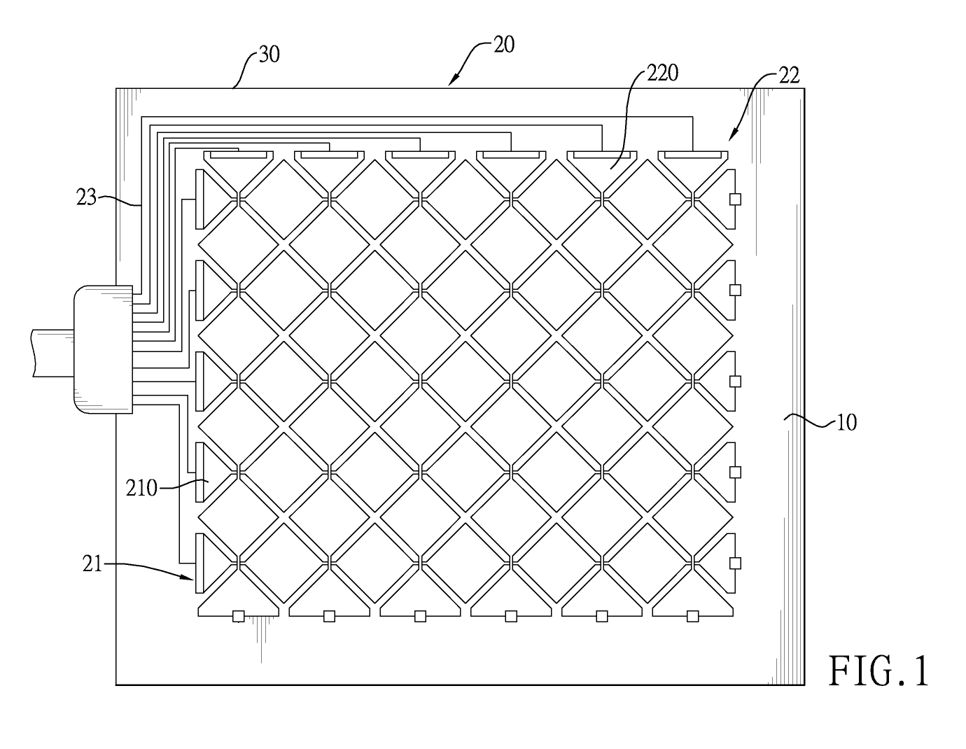

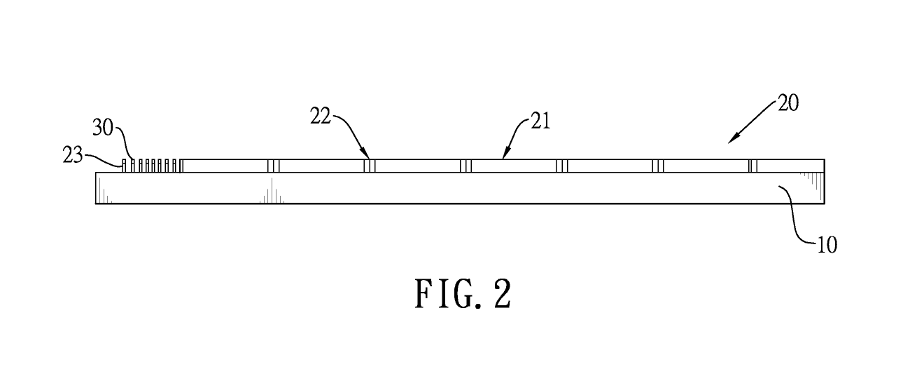

With reference to FIGS. 1 and 2, in the first embodiment of the present invention, a capacitive touch panel in accordance with the present invention is applied to a self capacitance touch panel having a single substrate and a single layer of medium layer and comprises a substrate 10, a medium layer 20 and multiple leading wires 30.

The substrate 10 may be made of glass or Polyethylene terephthalate (PET).

The medium layer 20 is formed on one side of the substrate 10 and has a rough surface, a first sense unit 21, a second sense unit 22 and a leading wire segment 23. The first sense unit 21 and second sense unit 22 are arranged along two different axial directions, and each sense unit 21,22 has multiple touch points 210,220. The axial directions may be perpendicular to each other, such that the touch points 210,220 of the first and second sense units 21,22 are arranged crisscross. The leading wire segment 23 is arranged on a position on the substrate 10 beside the first and second sense units 21,22 and preferably arranged on a periphery of the first and second sense units 21,22. The medium layer 20 can be made of Indium Tin Oxide (ITO), such that the sense units 21,22 and the leading wire segment 23 of the medium layer 20 are made of ITO with lithography or etching process.

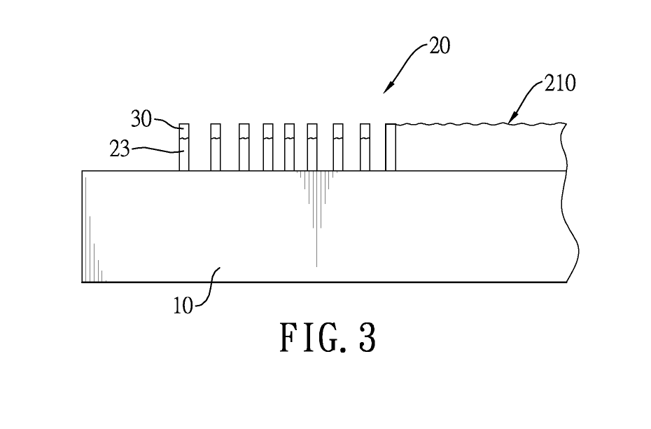

With further reference to FIG. 3, the leading wires 30 are formed on the leading wire segment 23 of the medium layer 20 and electrically connected with the touch points 210,220 of the sense units 21,22. The leading wires 30 may be made of sliver and is formed on the leading wire segment 23 by screen printing process or the like.

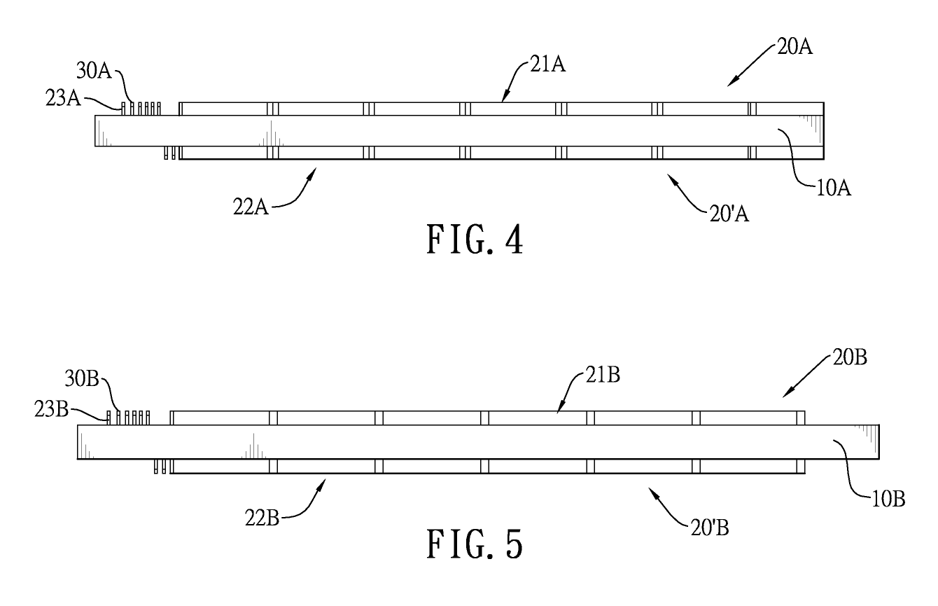

With reference to FIG. 4, in a second embodiment of the present invention, a capacitive touch panel is applied to a self capacitance touch panel having a single substrate and two layers of medium layers and comprises a substrate 10A, a first medium layer 20A, a second medium layer 20′A and multiple leading wires 23A.

The substrate 10A may be made of glass or Polyethylene terephthalate (PET) and has a first side and a second side.

The first medium layer 20A and the second medium layer 20′A are respectively formed on the sides of the substrate 10A. Each medium layer 20A,20′A has a sense unit 21A,22A and a leading wire segment 23A. The first sense unit 21A of the first medium layer 20A has multiple first touch points and is arranged along a first axial direction. The second sense unit 22A of the second medium layer 20′A has multiple second touch points and is arranged along a second axial direction that is different from the first axial direction to make the first touch points of the first sense unit 21A and the second touch points of the second sense unit 22A arranged crisscross. Preferably, the first axial direction is perpendicular to the second axial direction. The leading wire segment 23A of each medium layer 20A,20′A is arranged on a position on the corresponding side of the substrate 10A beside the corresponding sense unit 21A,22A and preferably arranged on a periphery of the corresponding sense unit 21A,22A. The leading wires 30A are formed on the leading wire segments 23A of the medium layers 20A,20′A and electrically connected with the touch points of the sense units 21A,22A. The leading wires 30A may be made of sliver and formed on the leading wire segments 23A by screen printing process or the like.

With reference to FIG. 5, in a third embodiment of the present invention, a capacitive touch panel is applied to a mutual capacitance touch panel having a single substrate and two layers of medium layers and comprises a substrate 10B, a first medium layer 20B, a second medium layer 20′B and multiple leading wires 30B. The first touch points of the first sense unit 21B and the second touch points of the second sense unit 22B are overlapped with each other. The leading wires 30B are formed on the leading wire segments 23B of the medium layers 20B,10′B and electrically connected with the touch points of the sense units 21B,22B.

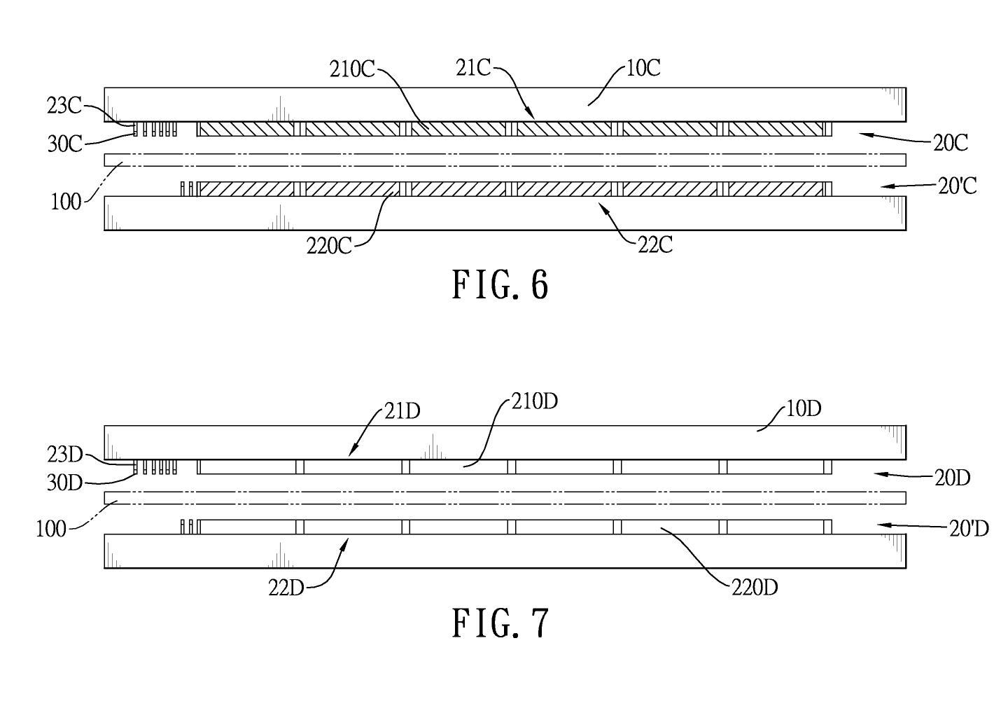

With reference to FIG. 6, in a fourth embodiment of the present invention, a capacitive touch panel is applied to a mutual capacitance touch panel having two substrates and two layers of medium layers and comprises two substrates 10C, a first medium layer 20C, a second medium layer 20′C, multiple leading wires 30C and a non-conductive layer 100. The first medium layer 20C is formed on the first substrate 20C at a side facing the second substrate 20C. The second medium layer 20′C is formed on the second substrate 10C at a side facing the first substrate 10C, such that the first and second medium layers 20C,20′C face to each other. Each medium layer 20C,20′C has a rough surface, a sense unit 21C,22C having multiple touch points 210C,220C and a leading wire segment 23C. The first touch points 210C of the first sense unit 21C and the second touch points 220C of the second sense unit 22C are arranged along different axial directions and crisscross. The leading wire segment 23C of each medium layer 20C,20′C is arranged on a position on the corresponding substrate 10C beside the corresponding sense unit 21C,22C and preferably arranged on a periphery of the corresponding sense unit 21C,22C. The leading wires 30C are formed on the leading wire segments 23C of the medium layers 20C,20′C and electrically connected with the touch points 210C,22C of the sense units 21C,22C.

With reference to FIG. 7, in a fifth embodiment of the present invention, a capacitive touch panel is applied to a mutual capacitance touch panel having two substrates and two layers of medium layers and comprises two substrates 10D, a first medium layer 20D, a second medium layer 20′ and multiple leading wires 30D. The first touch points 210D of the first sense unit 21D and the second touch points 220D of the second sense unit 22D are overlapped with each other. The leading wires 30D are formed on the leading wire segments 23D of the medium layers 20D,20′D and electrically connected with the touch points 210D,220D of the sense units 21D,22D.

The non-conductive layer 100 is formed between the first and second medium layers 20C,20′C or 20D,20′D to keep the medium layers 20C,20′C or 20D,20′D from interfering from each other.

Accordingly, with the rough surface(s) of the medium layer(s) 20, the leading wire 30 can be securely combined with the leading wire segment 23 and can be kept from detaching from the medium layer 23. Accordingly, the wide of the leading wire 30 can be efficiently reduced, and the area on the substrate 10 for arranging the touch points 210,220 can be increased to fit with design for a multi-functional touch panel.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A capacitive touch panel comprising:
a substrate;
a medium layer formed on the substrate and having
a rough surface;
a first sense unit and a second sense unit arranged along two different axial directions and each sense unit having multiple touch points; and
a leading wire segment; and
multiple leading wires formed on the leading wire segment of the medium layer and electrically connected with the touch points of the sense units.

2. The capacitive touch panel as claimed in claim 1, wherein the sense units and the leading wire segment of the medium layer are made of Indium Tin Oxide (ITO).

3. A capacitive touch panel comprising:
a substrate having a first side and a second side;
a first medium layer formed on the first side of the substrate and having
a rough surface;
a first sense unit arranged along a first axial direction and having multiple first touch points; and
a leading wire segment; and
a second medium layer formed on the second side of the substrate and having
a rough surface;
a second sense unit arranged along a second axial direction that is different from the first axial direction and having multiple second touch points; and
a leading wire segment; and
multiple leading wires formed on the leading wire segments of the first and second medium layers and electrically connected with the touch points of the first and second sense units.

4. The capacitive touch panel as claimed in claim 3, wherein the first sense unit and the leading wire segment of the first medium layer are made of Indium Tin Oxide (ITO).

5. The capacitive touch panel as claimed in claim 3, wherein the second sense unit and the leading wire segment of the second medium layer are made of Indium Tin Oxide (ITO).

6. The capacitive touch panel as claimed in claim 3, wherein the first touch points of the first sense unit and the second touch points of the second sense unit are arranged crisscross.

7. The capacitive touch panel as claimed in claim 3, wherein the first touch points of the first sense unit and the second touch points of the second sense unit are overlapped with each other.

8. A capacitive touch panel comprising:
two substrates including a first substrate and a second substrate;
a first medium layer formed on the first substrate and having
a first sense unit arranged along a first axial direction and having multiple first touch points; and
a leading wire segment; and
a second medium layer formed on the second substrate and having
a second sense unit arranged along a second axial direction that is different from the first axial direction and having multiple second touch points; and
a leading wire segment; and
multiple leading wires formed on the leading wire segments of the first and second medium layers and electrically connected with the touch points of the first and second sense units.

9. The capacitive touch panel as claimed in claim 8, wherein the first sense unit and the leading wire segment of the first medium layer are made of Indium Tin Oxide (ITO).

10. The capacitive touch panel as claimed in claim 8, wherein the second sense unit and the leading wire segment of the second medium layer are made of Indium Tin Oxide (ITO).

11. The capacitive touch panel as claimed in claim 8, wherein the first touch points of the first sense unit and the second touch points of the second sense unit are arranged crisscross.

12. The capacitive touch panel as claimed in claim 11 further comprising a non-conductive layer formed between the first and second medium layers.

13. The capacitive touch panel as claimed in claim 8, wherein the first touch points of the first sense unit and the second touch points of the second sense unit are overlapped with each other.

14. The capacitive touch panel as claimed in claim 11 further comprising a non-conductive layer formed between the first and second medium layers.

15. The capacitive touch panel as claimed in claim 8 further comprising a non-conductive layer formed between the first and second medium layers.
